(19) United States
(12) Patent Application Publication
(10) Pub. No.: US 2026/0017542 A1
(43) Pub. Date: Jan. 15, 2026

(54) METHOD FOR GENERATING CORPUS DATA BASED ON LARGE MODELS

(71) Applicant: BEIJING BAIDU NETCOM SCIENCE TECHNOLOGY CO., LTD., Beijing (CN)

(72) Inventors: Yiqing WU, Beijing (CN); Jie LIAO, Beijing (CN); Shaoyun LV, Beijing (CN); Chunguang CHAI, Beijing (CN); Xiaopeng CUI, Beijing (CN); Liping OUYANG, Beijing (CN); Hong ZHU, Beijing (CN); Shuai YAO, Beijing (CN); Zizhan YU, Beijing (CN); Na ZHAO, Beijing (CN)

(21) Appl. No.: 19/327,702

(22) Filed: Sep. 12, 2025

(30) Foreign Application Priority Data
Jul. 29, 2025 (CN) 202511052938.2

(51) Int. Cl. G06N 5/04

(52) U.S. Cl. CPC G06N 5/04

(57) ABSTRACT

A method for generating corpus data based on at least one large model is provided, which relate to the field of artificial intelligence technologies, and in particular to the fields of deep learning, large models, and intelligent question answering. The method includes: performing a content generation task by using the at least one large model based on a predetermined requirement condition to obtain a corpus content, where the content generation task includes a plurality of target tasks having dependency relationships, and the plurality of target tasks represent a reasoning process of the at least one large model for a corpus content to be generated; and determining target corpus data based on the corpus content and a reasoning process information related to the plurality of target tasks.

### CROSS-REFERENCE TO RELATED APPLICATION(S)

This application claims the benefit of Chinese Patent Application No. 202511052938.2 filed on Jul. 29, 2025, the whole disclosure of which is incorporated herein by reference.

### TECHNICAL FIELD

The present disclosure relates to the field of artificial intelligence technologies, and in particular to the fields of deep learning, large models, and intelligent question answering.

### BACKGROUND

A large language model (LLM) is an artificial intelligence model based on deep learning, which may be used to understand a requirement information input by a user and generate a corpus content that satisfies user's requirement intent.

### SUMMARY

The present disclosure provides a method for generating corpus data based on at least one large model, an intelligent agent, an electronic device, and a storage medium.

According to an aspect of the present disclosure, a method for generating corpus data based on at least one large model is provided, including: performing a content generation task by using the at least one large model based on a predetermined requirement condition to obtain a corpus content, where the content generation task includes a plurality of target tasks having dependency relationships, and the plurality of target tasks represent a reasoning process of the at least one large model for a corpus content to be generated; and determining target corpus data based on the corpus content and a reasoning process information related to the plurality of target tasks.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method provided in embodiments of the present disclosure.

According to another aspect of the present disclosure, a non-transitory computer-readable storage medium having computer instructions therein is provided, and the computer instructions are configured to cause a computer to implement the method provided in embodiments of the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 schematically shows an exemplary system architecture to which a method and apparatus for generating corpus data based on at least one large model may be applied according to an embodiment of the present disclosure;

FIG. 2 schematically shows a flowchart of a method for generating corpus data based on at least one large model according to an embodiment of the present disclosure;

FIG. 3 schematically shows an application scenario diagram of a method for generating corpus data based on at least one large model according to an embodiment of the present disclosure;

FIG. 4 schematically shows an application scenario diagram of a method for generating corpus data based on at least one large model according to another embodiment of the present disclosure;

FIG. 5 schematically shows a flowchart of a method for generating corpus data based on at least one large model according to another embodiment of the present disclosure;

FIG. 6 schematically shows a block diagram of an apparatus for generating corpus data based on at least one large model according to an embodiment of the present disclosure;

FIG. 7 schematically shows a structural block diagram of an artificial intelligence agent according to an embodiment of the present disclosure; and

FIG. 8 shows a schematic block diagram of an example electronic device that may be used to implement the method for generating corpus data based on at least one large model according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the acquisition, storage, and application of user personal information all comply with relevant laws and regulations, take necessary confidentiality measures, and do not violate public order and good customs.

The inventors have found that a large language model may be used by users to generate various types of files according to user requirements. For example, a large language model may be used to generate news releases, scripts and other text contents by processing requirement texts of users. For another example, a large language model may be used to generate information in various formats such as tables and codes to satisfy diversified user requirements. However, a corpus content generated by a large language model may have defects in semantic quality, which makes it difficult to apply the corpus content output by the large language model to specific scenarios such as language model training, and also makes it difficult to accurately satisfy the user's intent of obtaining corpus data that matches the actual requirement intent in a target scenario.

Embodiments of the present disclosure provide a method and apparatus for generating corpus data based on at least one large model, an intelligent agent, an electronic device, and a storage medium. The method for generating corpus data based on at least one large model includes: performing a content generation task by using the at least one large model based on a predetermined requirement condition to obtain a corpus content, where the content generation task includes a plurality of target tasks having dependency relationships, and the plurality of target tasks represent a reasoning process of the at least one large model for a corpus content to be generated; and determining target corpus data based on the corpus content and a reasoning process information related to the plurality of target tasks.

According to an embodiment of the present disclosure, by performing the content generation task using the large model based on the predetermined requirement condition and by representing the reasoning process of the large model outputting the corpus content through the reasoning process information that represents the plurality of target tasks in the content generation task and the dependency relationships between the target tasks, it is possible to avoid the deficiency of the large model outputting corpus content in a black-box manner that is difficult to interpret, which otherwise causes the generated corpus content to be inapplicable to specific artificial intelligence interaction scenarios such as language model training. Therefore, by generating target corpus data based on the corpus content and the reasoning process information, a language model to be trained may quickly learn execution logic for performing a content generation task according to the requirement condition by processing the reasoning process information in the target corpus data, and may improve the quality of the output content data according to the corpus content, thereby enhancing the training efficiency of the language model and enabling adaptation to a specific scenario of language model training. In addition, the reasoning process of the large model may be intuitively displayed through the reasoning process information and the corpus content in the target corpus data, thereby enhancing the efficiency for a target object to conduct approval, evaluation, editing, and other diverse operations on the target corpus data, and improving the processing efficiency of the target corpus data.

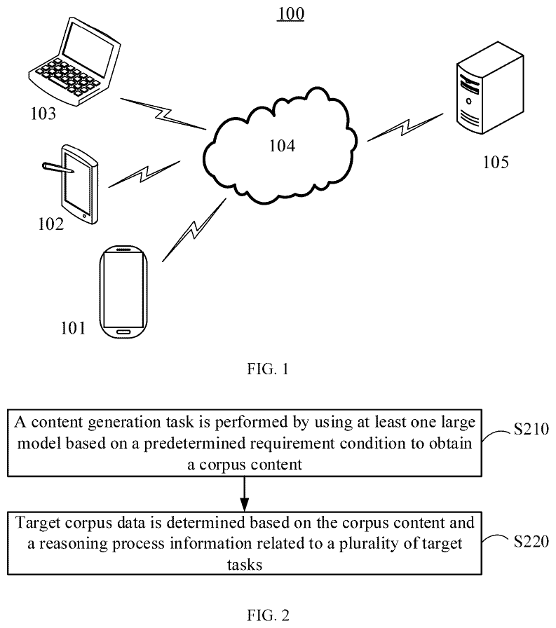

FIG. 1 schematically shows an exemplary system architecture to which a method and apparatus for generating corpus data based on at least one large model may be applied according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in another embodiment, the exemplary system architecture to which the method and apparatus for generating corpus data based on at least one large model may be applied may include a terminal device, but the terminal device may implement the method and apparatus for generating corpus data based on at least one large model provided in embodiments of the present disclosure without interacting with a server.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103, and the server 105. The network 104 may include various types of connections, such as wired and/or wireless communication links.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as knowledge reading applications, web browser applications, search applications, instant messaging tools, email clients and/or social platform software, etc. (for example only).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (for example only) that provides support for content browsed by the user using the first terminal device 101, the second terminal device 102, and the third terminal device 103. The background management server may analyze and process received data such as a user request, and return a processing result (such as a web page, information or data acquired or generated according to the user request) to the terminal devices.

It should be noted that the method for generating corpus data based on at least one large model provided in embodiments of the present disclosure may generally be performed by the first terminal device 101, the second terminal device 102, or the third terminal device 103. Accordingly, the apparatus for generating corpus data based on at least one large model provided in embodiments of the present disclosure may be disposed in the first terminal device 101, the second terminal device 102, or the third terminal device 103.

Alternatively, the method for generating corpus data based on at least one large model provided in embodiments of the present disclosure may generally be performed by the server 105. Accordingly, the apparatus for generating corpus data based on at least one large model provided in embodiments of the present disclosure may generally be disposed in the server 105. The method for generating corpus data based on at least one large model provided in embodiments of the present disclosure may also be performed by a server or server cluster different from the server 105 and capable of communicating with the first terminal device 101, the second terminal device 102, the third terminal device 103, and/or the server 105. Accordingly, the apparatus for generating corpus data based on at least one large model provided in embodiments of the present disclosure may be disposed in a server or server cluster different from the server 105 and capable of communicating with the first terminal device 101, the second terminal device 102, the third terminal device 103, and/or the server 105.

For example, a large model may be deployed in the server 105, or a large model may be deployed in a server or server cluster that is different from the server 105 and capable of communicating with the first terminal device 101, the second terminal device 102, the third terminal device 103, and/or the server 105.

It should be understood that the numbers of terminal devices, networks, and servers in FIG. 1 are merely schematic. According to implementation needs, any number of terminal devices, networks, and servers may be provided. For ease of explanation of the method for generating corpus data based on at least one large model in embodiments of the present disclosure, the server may be used as an execution subject of the method provided in embodiments of the present disclosure.

FIG. 2 schematically shows a flowchart of a method for generating corpus data based on at least one large model according to an embodiment of the present disclosure.

As shown in FIG. 2, the method for generating corpus data based on at least one large model includes operation S210 to operation S220.

In operation S210, a content generation task is performed by using the at least one large model based on a predetermined requirement condition to obtain a corpus content.

In operation S220, target corpus data is determined based on the corpus content and a reasoning process information related to a plurality of target tasks.

According to an embodiment of the present disclosure, the large model may be constructed based on a large language model. The large model may perform the content generation task according to the input predetermined requirement condition to output a corpus content. The predetermined requirement condition may represent a requirement intent of the target object, such as a topic-related requirement intent, a corpus format-related intent, a corpus style-related intent, and the like. The predetermined requirement condition may further include a knowledge base for performing the content generation task. The specific type of the predetermined requirement condition is not limited in embodiments of the present disclosure.

In some embodiments, the corpus content may be output by a plurality of large models through a dialogue. In other embodiments, the corpus content may be generated and output by one or more large models through a dialogue with a designated object. The number of large models is not limited in embodiments of the present disclosure.

In some embodiments, the large model may be obtained through fine-tuning based on a predetermined training condition. The large model may also perform the content generation task according to the predetermined requirement condition by using a prompt word related to the predetermined requirement condition, thereby obtaining corpus data.

According to an embodiment of the present disclosure, the corpus content may be any type of information. For example, the corpus content may include multiple types of information such as text, charts, tables, and codes. The corpus content may include any information content expressed in natural language, such as news releases, intelligent customer service response texts, or script dialogue texts.

According to an embodiment of the present disclosure, the content generation task includes a plurality of target tasks having dependency relationships, and the plurality of target tasks represent a reasoning process of the large model with respect to the corpus content to be generated. The large model performs semantic understanding on the predetermined requirement condition and, according to a semantic understanding result, constructs and performs a plurality of target tasks and dependency relationships. Thus, the large model may perform the plurality of target tasks according to the dependency relationships, and fuse respective execution results of the plurality of target tasks to generate a corpus content that matches the intent represented by the predetermined requirement condition.

For example, for a content generation task related to script corpus to be generated, the plurality of target tasks may include a script theme understanding task, a script character planning task, a script scene construction task, a script dialogue generation task, and a script verification task. The plurality of target tasks may be performed according to an execution order of the target tasks, and the dependency relationships may be represented as the execution order of the plurality of target tasks. By performing the plurality of target tasks such as the script theme understanding task, the script character planning task, the script scene construction task, the script dialogue generation task, and the script verification task in the execution order, the large model may obtain respective execution results of the plurality of target tasks, and by fusing the plurality of execution results, obtain script corpus that matches the predetermined requirement condition.

In some embodiments, the reasoning process information may include task-related information of the plurality of target tasks in the content generation task and dependency relationship information representing the dependency relationships. The task-related information may include the execution results of the target tasks, such as character names and character personality description information obtained by performing the script character planning task. The dependency relationship information may represent association relationships between the task-related information of the plurality of target tasks.

According to an embodiment of the present disclosure, the reasoning process information may be determined by structured editing of system logs related to execution of the content generation task by the large model. For example, it is possible to perform relationship information reading and structured editing on a system log information of the content generation task related to the predetermined requirement condition to obtain the task-related information of the plurality of target tasks and the dependency relationships between the plurality of target tasks, thereby generating the reasoning process information. However, the present disclosure is not limited thereto, and the reasoning process information may also be determined based on editing performed through an interactive operation of the target object. The specific manner of obtaining the reasoning process information is not limited in embodiments of the present disclosure.

In an embodiment, it is also possible to perform key information understanding and extraction on a reasoning text of a “deep reasoning” process generated by the large model while performing the content generation task to obtain the task-related information and dependency relationships of the plurality of target tasks in the reasoning process information, thereby obtaining the reasoning process information.

In some embodiments, determining the target corpus data according to the corpus content and the reasoning process information may include associating the corpus content with the reasoning process information. This allows the language model to be trained to perform semantic understanding based on the associated reasoning process information and corpus content in the target corpus data, so as to quickly adjust parameters and optimize the model by learning the reasoning process of the large model, thereby improving the training efficiency of the language model and enhancing the model performance of the language model.

In some embodiments, the reasoning process information may be a structured information. For example, the task-related information of the plurality of target tasks and the dependency relationships may be expressed in a structured format such as tables, headings, or topological diagrams, so as to clearly represent an execution process and task condition of the large model performing the content generation task. As a result, the target corpus data may accurately represent the reasoning process of the large model in generating the corpus content based on the structured reasoning process information, and the information richness of the target corpus data may be improved based on the associated corpus content and reasoning process information. This avoids the situation where the target corpus data has poor interpretability due to the black-box mechanism of deep learning models, which may otherwise limit applicability of the target corpus data in specific application scenarios such as language model training, script creation, and code editing. Accordingly, the target corpus data may meet diversified data requirement conditions in specific scenarios, thereby improving a quality level of the target corpus data.

In some embodiments, the target corpus data is used to train a language model to be trained. The language model to be trained may be constructed based on principles of large language models, and the number of model parameters of the language model may be smaller than that of the large model configured to perform the content generation task. Accordingly, the language model may be trained based on the structured reasoning process information and corpus content, thereby achieving full distillation of model capabilities of a large model with a great parameter scale and strong performance into a language model with a small parameter scale. The trained language model may be deployed on a computing device such as a server to enhance the capability of the computing device to address requirements in specific scenarios such as intelligent customer service, knowledge question answering, and script creation, thereby improving user experience and reducing computational overhead.

In some embodiments, the method for generating corpus data based on at least one large model may further include: displaying a reasoning process topology related to the reasoning process information; and, in response to an editing operation on the reasoning process topology, updating at least one of the target tasks and the dependency relationships to obtain the reasoning process information.

According to an embodiment of the present disclosure, the reasoning process topology includes node elements representing the target tasks and edge elements representing the dependency relationships. The reasoning process topology may present the plurality of target tasks and the dependency relationships between the target tasks in any type of topological structure, such as a chain topology or a tree topology.

According to an embodiment of the present disclosure, the editing operation on the reasoning process topology may include modifying or deleting at least one of the node elements and edge elements in the currently displayed reasoning topology by the target object to obtain an updated reasoning process topology. The updated reasoning process topology may be displayed on the interactive interface. By updating the node elements in the reasoning process topology, it is possible to add, delete, or modify target tasks and dependency relationships in the content generation task to generate updated task-related information of the target tasks, or adjust the execution order of the plurality of target tasks to achieve execution modes such as a parallel execution mode or a serial execution mode for performing the plurality of target tasks. The corpus content for determining the target corpus data may also be determined based on the updated content generation task and reasoning process information.

In some embodiments, the editing operation may further include a task editing operation for editing the target task corresponding to a node element. For example, if the target task is a weather query task, the task editing operation may be performed on the node element representing the weather query task to input task parameters for the weather query task, such as location and time period. Accordingly, the weather query task may be performed based on the location and time period indicated by the task parameters input through the task editing operation to obtain an execution result.

In some embodiments, the editing operation may further include a selection operation performed on the reasoning process topology currently displayed on the interactive interface. In this way, the reasoning process information may be determined according to the node elements and edge elements in the currently displayed reasoning process topology, and the large model may perform the content generation task according to the plurality of target tasks and dependency relationships corresponding to the reasoning process topology to generate corpus content. Thus, the corpus content may better meet the actual requirements of the target object, improving the quality of the target corpus data and the matching degree with specific requirement scenarios.

According to embodiments of the present disclosure, by displaying the reasoning process topology representing the current reasoning process information, the target object may clearly understand the execution process of the content generation task performed by the large model according to the predetermined requirement condition, and may perform an editing operation on the currently displayed reasoning process topology according to the actual requirement for the corpus data. As a result, the large model may perform the content generation task according to a plurality of target tasks and dependency relationships corresponding to the updated reasoning process topology, so that the generated corpus content may accurately satisfy the actual requirements of the target object. Meanwhile, by performing the editing operation on the reasoning process topology, the reasoning process and task execution process of the large model in performing the content generation task may be guided, which simplifies the complexity of interactive operations for intervening in the content generation task performed by the large model and improves the efficiency of corpus data generation.

According to an embodiment of the present disclosure, the target tasks may include a tool invocation task. By performing the tool invocation task, the large model may invoke a target tool to perform a specified task, thereby obtaining an intermediate result for generating corpus content.

According to an embodiment of the present disclosure, the target tool may be a tool resource having a specific task execution function. For example, the tool resource may include an information search engine, a code execution tool, an image recognition tool, and the like. The large model may invoke the target tool by performing the tool invocation task, so as to perform the specified task according to tool invocation parameters output by the large model, and obtain a tool invocation execution result of the tool resource performing the specified task as the intermediate result.

The tool resource may include, for example, a document retrieval tool, a web search tool, an image processing tool, a language translation tool, and the like.

Specifically, the document retrieval tool may perform information extraction such as document summarization and question answering, perform a database query tool task, and parse a query result. The web search tool may search web pages and acquire relevant page contents. The code execution and debugging tool may run program scripts in a specified language and return execution results of the program script. The image processing tool may perform understanding and question answering on image content, or generate images from natural language. Additional tool resources may include an optical character recognition and extraction tools, a language translation tool, a multimodal data fusion tool, or the like.

In some embodiments, the reasoning process information may further include a tool task-related information of the tool invocation task. The tool task-related information may include a tool description information of the invoked target tool, a task execution parameter of the tool invocation task, and the like. The tool task-related information may be represented in a structured manner to meet the actual requirements for target corpus data in specific scenarios.

In some embodiments, the reasoning process information includes a task description information describing the execution process of the tool invocation task. The task description information related to the tool invocation task includes the tool task-related information of the tool invocation task. The tool task-related information may include the tool description information of the invoked target tool, the task execution parameter of the tool invocation task, and the like. The tool task-related information may be represented in a structured manner to meet the actual requirements for target corpus data in specific scenarios.

For another example, the task description information related to the tool invocation task may further include a name field and version identifier of the target tool, a target tool invocation parameter template, a result verification rule for the intermediate result output by the target tool, a timeout and retry strategy required for invoking the target tool to perform the specified task, an execution condition for invoking the target tool to perform the specified task, and the like.

According to embodiments of the present disclosure, since the reasoning process information includes the task description information related to the tool invocation task, the target corpus data determined according to the reasoning process information and the corpus content may be used to guide a language model to be trained to accurately learn the model capability of performing content generation tasks by invoking tool resources, according to a tool description information, a tool parameter range, and intermediate result examples in the task description information. Thus, the target corpus data may be adapted to scenarios of training and testing language models, thereby improving the quality of the target corpus data.

In some embodiments, a tool node element in the reasoning process topology may represent a tool invocation task. The target object may add, delete, or modify a task execution parameter of the tool invocation task by performing an editing operation on the tool invocation node element. In this way, the execution process of the content generation task performed by the large model may be conveniently and flexibly updated by editing the reasoning process topology, so as to obtain corpus content that may further meet the actual requirement intent of the target object. Accordingly, the reasoning process information and corpus content related to the large model may be conveniently obtained based on the editing operation performed by the target object, thereby rapidly generating the target corpus data, improving the generation efficiency of the target corpus data, reducing the complexity of interactive operations, and enhancing user experience.

In some embodiments, the plurality of target tasks may further include a reasoning task, which may represent a task for the large model to analyze or determine based on the predetermined requirement condition or intermediate result. For example, the reasoning task may include a preliminary reasoning task, a self-check task, an iterative reasoning task, a summarization and extraction task, a format conversion task, a classification and intent recognition task, a decision-making and strategy formulation task, and the like.

Preliminary reasoning task: rapidly generating candidate answers or solutions according to dialogue context.

Self-check task: checking the consistency, logic, and completeness of the execution result of a previous reasoning task, and outputting a check report or a list of questions.

Iterative reasoning task: supplementing, correcting, or reconstructing the input content of a previous reasoning task based on a self-check feedback or a tool result.

Summarization and extraction task: extracting key elements, concepts, or facts from complex information, and generating a concise summary or a list of key points.

Format conversion task: converting textual content in the execution result of a target task into different formats such as question-answer pairs, step lists, code comments, or tables.

Classification and intent recognition task: determining user intent, sentiment tendency, or text type, and providing a basis for assigning different tool resources to subsequent target tasks.

Decision-making and strategy formulation task: evaluating the advantages and disadvantages of various options in a multi-option scenario, and providing an optimal or feasible strategy.

In some embodiments, the target corpus data may be used to train a language model to be trained. The language model to be trained may be constructed based on principles of large language models, and the number of model parameters of the language model may be smaller than that of the large model configured to perform the content generation task. Accordingly, the language model may be trained based on the structured reasoning process information and corpus content, thereby achieving full distillation of model capabilities of a large model with a great parameter scale and strong performance into a language model with a small parameter scale. The trained language model may be deployed on a computing device such as a server to enhance the capability of the computing device to address requirements in specific scenarios such as intelligent customer service, knowledge question answering, and script creation, thereby improving user experience and reducing computational overhead.

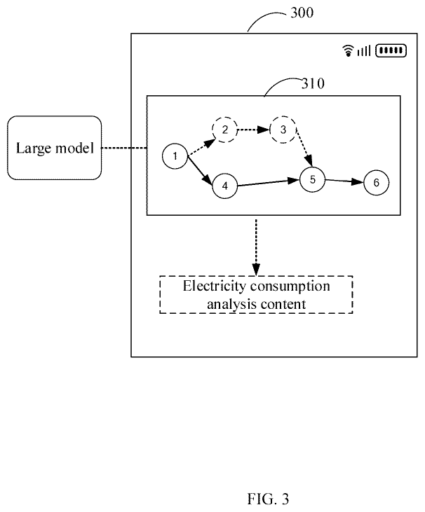

FIG. 3 schematically shows an application scenario diagram of a method for generating corpus data based on at least one large model according to an embodiment of the present disclosure.

As shown in FIG. 3, a first interactive interface 300 displays a reasoning process topology 310 of a large model performing a content generation task, where node element 2, node element 3, and edge elements connected to node element 2 and node element 3 may be elements added based on editing operations performed by the target object. In response to the editing operation of the target object, the task-related information of the target tasks respectively corresponding to node element 2 and node element 3 may be determined, and a plurality of target tasks and dependency relationships represented by the reasoning process topology 310 may be determined.

The reasoning process topology 310 may include a plurality of node elements and edge relationships between the node elements. The plurality of node elements may represent a plurality of target tasks, and the plurality of target tasks are performed according to the dependency relationships indicated by the edge relationships. Node element 1 may represent a first target task, which may be a reasoning task for task planning corresponding to a question “Predict the electricity consumption variation of Company A in 2026”. Node element 2 represents a tool scheduling task for acquiring revenue reports of Company A over the past three years. An execution result of the tool invocation task corresponding to node element 2, that is, “the revenue reports of Company A over the past three years”, may serve as an intermediate result for performing the target task corresponding to node element 3. Node element 3 represents a tool scheduling task for performing semantic understanding on the revenue reports of Company A over the past three years to generate a content of analyzing the product output variation and a content of predicting the product output in 2026. Node element 4 may represent a data search task for acquiring electricity consumption variation data of Company A over the past three years. Node element 5 may represent a tool scheduling task for performing semantic analysis on the electricity consumption variation data of Company A over the past three years, the content of analyzing the product output variation, and the content of predicting the product output in 2026, by using the large model, and for outputting a content of analyzing the electricity consumption of Company A. Node element 6 represents a reasoning task for performing self-check on the content of analyzing the electricity consumption of Company A. Thus, the corpus content output by the large model may be an electricity consumption analysis content for Company A in 2026. The electricity consumption analysis content may include diverse data such as multiple text paragraphs, tables, and charts.

It should be noted that the information acquisition in any embodiment of the present disclosure, including but not limited to revenue reports and electricity consumption data, is performed after obtaining authorization from relevant personnel or organizations. Before acquiring the data, the actual purpose of the data acquisition is disclosed to satisfy the actual requirements of the target object with data access permissions. Moreover, necessary encryption or desensitization measures are applied to the acquired data to avoid information leakage, which complies with relevant laws and regulations and does not violate public order and good customs.

Based on the plurality of node elements and edge relationships represented by the reasoning process topology 310, the large model may be instructed to perform the content generation task, for example, to perform a plurality of target tasks in the content generation task based on a mapping relationship. The target object may perform an interactive operation on the reasoning process topology 310 to add, delete, or replace any node element or edge relationship, thereby updating the reasoning process information through the interactive operation on the first interactive interface 300. As a result, the large model may perform the content generation task based on the plurality of target tasks and dependency relationships in the updated reasoning process information to output the electricity consumption analysis content.

In some embodiments, performing a content generation task by the large model based on the predetermined requirement condition to obtain corpus content may include: performing the content generation task by a plurality of large models based on the predetermined requirement condition to obtain a plurality of candidate corpus contents; and determining the corpus content from the plurality of candidate corpus contents in response to a target operation on the candidate corpus contents.

According to an embodiment of the present disclosure, the plurality of candidate corpus contents may be different response contents generated by a plurality of large models based on the same predetermined requirement condition and requirement information. For example, the plurality of large models may have different model parameters, and the plurality of large models may perform content generation tasks on the same question text based on the predetermined requirement condition to output a plurality of candidate answer texts. The content generation tasks respectively performed by the plurality of large models are related to different reasoning process information.

In some embodiments, the target operation may include an adoption operation for adopting a candidate corpus content as the corpus content. The target object may quickly generate the corpus content for the target corpus data by performing the adoption operation, and determine the reasoning process information corresponding to the corpus content according to the adoption operation for generating the target corpus data.

In some embodiments, the target corpus data may include an operation information of a target interactive operation related to the target corpus content. For example, the target corpus data may carry an editing information of an editing operation performed on the intermediate corpus content.

In an example, the interactive interface may display the candidate corpus content output by any large model during the dialogue process, and the candidate corpus content may be displayed in a corpus content box using light-colored characters. When the target object performs an adoption operation on at least one content word or content paragraph in the candidate corpus content, the content word or content paragraph of the candidate corpus content may be displayed in dark-colored characters, and the content word or content paragraph corresponding to the dark-colored characters may be determined as the corpus content. Accordingly, the target corpus data may be generated based on the reasoning process information corresponding to the dark-colored characters.

In an example, the target operation may be a cancellation operation. The interactive interface may display the candidate corpus content output by one or more large models, and the candidate corpus content may be displayed in a corpus content box using light-colored characters. When the target object performs a cancellation operation on at least one content word or content paragraph in the candidate corpus content, the candidate corpus content may be cleared and the large model may be instructed to re-perform the corpus content generation task to generate and display updated candidate corpus content. This process continues until the target object performs an adoption operation on the currently generated candidate corpus content to determine the corpus content and reasoning process information for the target corpus data.

In some embodiments, the target operation may further include an editing operation for editing the currently displayed candidate corpus content. The editing operation may indicate that the target object edits the candidate corpus content, such as deleting or adding words, tables, or other content. Accordingly, the adoption operation may be performed on the edited candidate corpus content to determine the corpus content for the target corpus data. In this case, the target corpus data may be determined based on the corpus content, the corresponding reasoning process information, and the editing operation information related to the editing operation, so that in specific scenarios such as corpus review and language model training, the generation process of the corpus content may be clearly understood, thereby improving the review efficiency for corpus review and the training quality for language model training.

According to embodiments of the present disclosure, by displaying a plurality of candidate corpus contents on the interactive interface and determining corpus content from the plurality of candidate corpus contents through target operations performed on the candidate corpus contents by the target object, a high-quality corpus content may be obtained conveniently. Furthermore, by generating the target corpus data according to the operation information of the target operation, the corpus content, and the reasoning process information, the target corpus data may be used to accurately train a model capability that may be adapted to the actual requirements of the target object, thereby making an interactive annotation operation for data annotation of language models more convenient and improving the efficiency of corpus data annotation.

In some embodiments, determining the corpus content from the plurality of candidate corpus contents in response to the target operation on the candidate corpus contents may further include: determining a target sub-content from the candidate corpus contents in response to a target operation on a sub-content of the candidate corpus contents; and performing semantic fusion on a plurality of target sub-contents to obtain the corpus content.

According to an embodiment of the present disclosure, the sub-content in the candidate corpus content may include paragraph content, partial table content, keyword content, etc., in the corpus content. For example, the sub-content may include abstract text and table text content in paper-type corpus content.

In some embodiments, each of the plurality of candidate corpus contents may have multiple sub-contents, and the target operation on the sub-content may include an adoption operation on the sub-content. The sub-content related to the adoption operation may be a content output by the large model by performing the content generation task, or may be a content obtained after the target object performs an editing operation on the content output by performing the content generation task.

According to an embodiment of the present disclosure, fusing the plurality of target sub-contents may include performing semantic fusion on the plurality of target sub-contents adopted by the target object from different candidate corpus contents to obtain the corpus content. For example, the corpus content may be determined by concatenating the plurality of sub-contents.

For another example, fusing the plurality of target sub-contents may include: performing a semantic fusion on the plurality of target sub-contents by using a designated large model to obtain corpus content with coherent semantic logic and smooth language expression. The target object may perform an adoption operation on an abstract sub-content in a first candidate corpus content, perform an adoption operation on a viewpoint discussion paragraph as a sub-content in a second candidate corpus content, and perform an adoption operation on a chart sub-content in a third candidate corpus content. The designated large model may then perform a semantic fusion on the abstract sub-content, the viewpoint discussion paragraph, and the chart sub-content from different candidate corpus contents to obtain the corpus content.

According to embodiments of the present disclosure, determining the corpus content by fusing sub-contents from one or more candidate corpus contents allows the target object to enhance the quality of the corpus content by finely editing and adopting high-quality sub-contents from the plurality of candidate corpus contents that better match the actual requirements, and to improve the language fluency and semantic logic consistency of the corpus content by performing semantic fusion on the plurality of selected sub-contents, thereby improving the data quality of the target corpus data.

In some embodiments, the target corpus data may further include an operation information of the target operation performed on the candidate corpus data. The operation information may include, for example, an operation information of the adoption operation, an operation information of the editing operation, and other information related to various types of target operations performed by the target object. Thus, the operation information in the target corpus data may indicate the editing process of the target object with respect to the corpus data, enabling the language model to be trained to learn the reasoning process of relevant objects by understanding the operation information, the corpus content, and the reasoning process information, thereby improving the model capability of the language model.

In some embodiments, determining the target corpus data based on the operation information, the reasoning process information, and the corpus content may further include determining an adoption rate of each large model based on the operation information. The adoption rate may indicate a statistical proportion of the candidate corpus content output by the large model that has been subjected to adoption operations by the target object. For example, adoption rate=number of candidate corpus contents subjected to adoption operations/number of output candidate corpus contents. Accordingly, by including the adoption rate in the target corpus data, the performance of the language model may be enhanced, and the quality of the content output by the trained language model may be improved.

In an embodiment, when the adoption rate of a large model is greater than 80%, a content generation operation may be performed based on the content information edited by the target object during a process where the target object performs an editing operation on the candidate corpus content. When the adoption rate of the large model is less than 30%, the large model may perform the content generation task according to complete content information edited by the target object, or may prompts the target object to generate the corpus content through the editing operation.

In some embodiments, the method for generating corpus data based on at least one large model further includes: performing a content quality detection on at least one candidate corpus content to obtain a content quality score.

In some embodiments, the content quality score corresponding to the at least one candidate corpus content may be displayed on the interactive interface, and the target object may perform a target operation on the candidate corpus content according to the displayed content quality score.

In some embodiments, the interactive interface may further display a content quality score related to the candidate corpus content or sub-content within the candidate corpus content. The content quality score may represent an evaluation result of the candidate corpus content or sub-content with respect to content quality indicators such as context relevance, topic relevance, and language fluency.

For example, for each candidate corpus content output by a large model, the content quality score may be determined in the following manner.

For the language fluency indicator, the language fluency of the candidate corpus content is evaluated by a designated large model with corpus evaluation capability, to obtain a language fluency evaluation result.

For the context relevance indicator, a cosine similarity between the candidate corpus content and the context content may be calculated using an attention network algorithm, which is taken as the context relevance evaluation result.

For the coverage and completeness indicator, the coverage and completeness of the candidate corpus content is evaluated based on a predefined list of key elements such as entities and intent points, to obtain a coverage and completeness evaluation result.

For the semantic logic consistency indicator, a large language model may detect whether internal semantics of the candidate corpus content contain logical contradictions or logical leaps to obtain a logic consistency detection result.

By integrating the language fluency evaluation result, the coverage and completeness evaluation result, the context relevance evaluation result, and the logic consistency detection result, and performing quantitation processing, the content quality score of the candidate corpus content is obtained. The content quality score may be displayed on the interactive interface to help the target object select high-quality candidate corpus content for determining the target corpus content.

In an embodiment, the corpus content may further be determined based on a fusion operation performed by the target object on a plurality of candidate corpus contents.

For example, the target object may perform a fusion operation on a plurality of candidate corpus contents. A designated large model may automatically select a plurality of sub-contents whose content quality scores satisfy a predetermined score condition from among the plurality of candidate corpus contents to perform semantic fusion, so as to fuse high-score paragraphs or key phrases to generate updated candidate corpus content. The target object may perform an adoption operation on the updated candidate corpus content to obtain the corpus content.

The plurality of large models used to generate the candidate corpus contents may be determined based on interactive operations of the target object. For example, the target object may perform an interactive operation based on respective version numbers, model names and other information of a plurality of candidate large models, so as to determine the plurality of large models used to generate the candidate corpus contents.

FIG. 4 schematically shows an application scenario diagram of a method for generating corpus data based on at least one large model according to another embodiment of the present disclosure.

As shown in FIG. 4, the application scenario includes a second interactive interface 400. The second interactive interface 400 displays a first candidate corpus content 410 and a second candidate corpus content 420 respectively output by a first large model and a second large model by performing a content generation task for a predetermined requirement condition of “generating a news release for the exhibition in City A”. The target object may perform a selection operation on abstract A and chart A in the first candidate corpus content 410 to determine two target sub-contents in the first candidate corpus content 410, and may perform a selection operation on news body B in the second candidate corpus content 420 to determine a target sub-content in the second candidate corpus content 420. By performing a semantic fusion on the plurality of target sub-contents such as abstract A, news body B, and chart A using a designated large model, a fluent news release for reporting the exhibition in City A may be obtained.

In some embodiments, the target corpus data includes the corpus content, the reasoning process information, the operation information related to the target operation, and the content quality score.

In some embodiments, the target corpus data may include a plurality of data groups, and each data group may include associated corpus content, reasoning process information, operation information related to the target operation, and content quality score. The plurality of data groups may be arranged based on the semantic logical relationships between the plurality of corpus data. According to the semantic logical relationship between the plurality of data groups, a language model may sufficiently learn and understand corpus content that satisfies the content quality score requirement, as well as the reasoning process and the editing operation of the content generation task for generating the corpus content, thereby improving the learning speed and accuracy of the language model and further enhancing the training effect for training the language model.

In some embodiments, the target corpus data may include candidate corpus contents, content quality scores corresponding to the candidate corpus contents, generation timestamps, and other detailed generation process information. Such detailed generation process information in the target corpus data may facilitate relevant personnel in reviewing or studying the corpus content, or may enable a language model trained using the target corpus data to clearly and fully learn the detailed content generation process, thereby improving the execution capability and adaptability of the language model in performing content generation tasks for predetermined topics.

According to an embodiment of the present disclosure, the corpus content is determined through a dialogue conducted by a plurality of large models based on the predetermined requirement condition. For example, a plurality of role-based large models may conduct a dialogue to understand the already generated corpus content as the context content during the dialogue, and then perform content generation tasks.

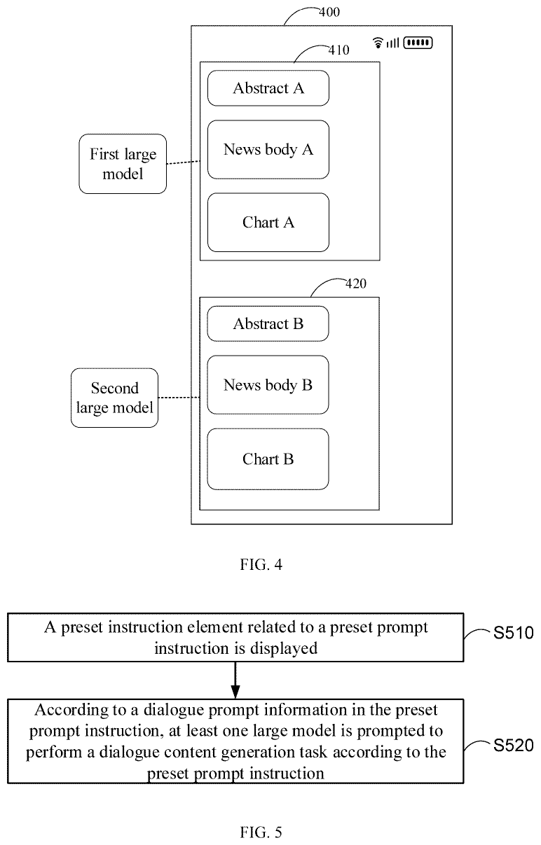

FIG. 5 schematically shows a flowchart of a method for generating corpus data based on at least one large model according to another embodiment of the present disclosure.

As shown in FIG. 5, the method for generating corpus data based on at least one large model includes operation S510 to operation S520.

In operation S510, a preset instruction element related to a preset prompt instruction is displayed.

In operation S520, in response to a triggering operation on the preset instruction element and according to a dialogue prompt information in the preset prompt instruction, at least one large model is prompted to perform a dialogue content generation task according to the preset prompt instruction.

According to an embodiment of the present disclosure, a large model may conduct a dialogue with other large models by performing a dialogue content generation task. For example, the large model may perform semantic understanding on a context content and a predetermined requirement condition, and output a corpus content.

According to an embodiment of the present disclosure, the dialogue prompt information in the preset prompt instruction may indicate a task requirement condition of a dialogue content generation task that the target object currently requires the large model to perform. For example, the preset prompt instruction may instruct the large model to perform a dialogue content generation task according to a dialogue prompt information corresponding to requirement conditions such as “describe content in the form of table”, “simplify the answer”, “expand details”, “convert format”, or “list key points”, and to output a dialogue content that matches the task requirement condition indicated by the dialogue prompt information.

In some embodiments, the target object is allowed to edit an initial preset instruction element to generate a preset prompt instruction element that matches the task requirement condition. The preset prompt instruction may be configured with a dialogue prompt information to facilitate a quick command control over at least one large model during the dialogue process, thereby improving the generation efficiency of target corpus data.

In some embodiments, tool resources may also be invoked to run in a controlled sandbox environment with isolated file systems and network access, to prevent malicious code or data leakage. After the tool resource is invoked, an execution result of the tool resource, together with an utterance content or intermediate utterance content having a mapping relationship thereto, as well as context content, may be submitted to a designated large model for quality evaluation. A scope of evaluation includes, but is not limited to: completeness of the result (e.g., whether a target task execution result contains required fields), semantic matching degree (e.g., the relevance to the expected answer), and reliability evaluation (e.g., source credibility score of search results obtained after the execution of the tool invocation task).

According to embodiments of the present disclosure, by performing interactive operations on preset instruction elements, the target object may conveniently and quickly provide prompts to a plurality of large models participating in the dialogue, to control the dialogue development direction, word count limits, and other dialogue patterns during the dialogue between the plurality of large models so as to meet the actual requirements of the target object, thereby improving the generation efficiency of the target corpus data and reducing the interaction complexity of performing annotation operations on the target corpus data.

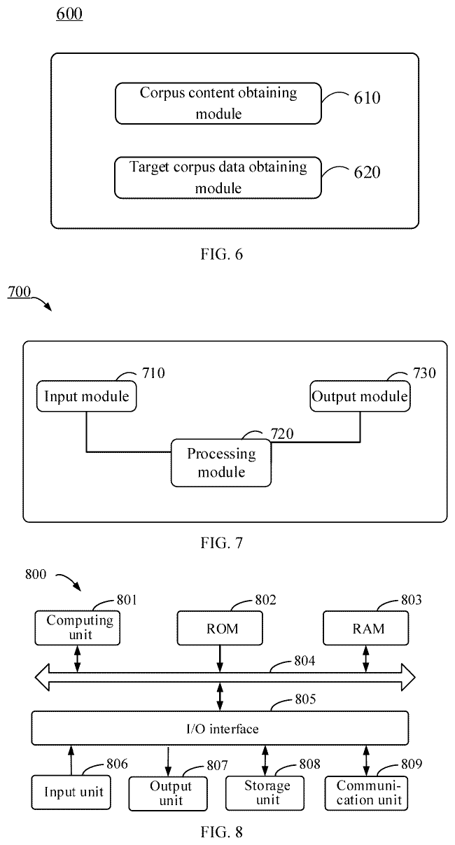

FIG. 6 schematically shows a block diagram of an apparatus for generating corpus data based on at least one large model according to an embodiment of the present disclosure.

As shown in FIG. 6, an apparatus 600 for generating corpus data based on at least one large model includes a corpus content obtaining module 610 and a target corpus data obtaining module 620.

The corpus content obtaining module 610 is configured to perform a content generation task by using the at least one large model based on a predetermined requirement condition to obtain a corpus content, where the content generation task includes a plurality of target tasks having dependency relationships, and the plurality of target tasks represent a reasoning process of the at least one large model for a corpus content to be generated.

The target corpus data obtaining module 620 is configured to determine target corpus data based on the corpus content and a reasoning process information related to the plurality of target tasks.

According to an embodiment of the present disclosure, the apparatus for generating corpus data based on at least one large model further includes a first display module and a reasoning process information obtaining module.

The first display module is configured to display a reasoning process topology related to the reasoning process information, where the reasoning process topology includes node elements representing the target tasks and edge elements representing the dependency relationships.

The reasoning process information obtaining module is configured to, in response to an editing operation on the reasoning process topology, update at least one of the target tasks and the dependency relationships to obtain the reasoning process information.

According to an embodiment of the present disclosure, the target tasks include a tool invocation task; the at least one large model is configured to invoke a target tool to perform a specified task by performing the tool invocation task, to obtain an intermediate result for generating the corpus content; and the reasoning process information includes a task description information describing an execution process of the tool invocation task.

According to an embodiment of the present disclosure, the corpus content obtaining module includes a candidate corpus content obtaining unit and a corpus content obtaining unit.

The candidate corpus content obtaining unit is configured to perform the content generation task by using a plurality of large models based on the predetermined requirement condition to obtain a plurality of candidate corpus contents.

The corpus content obtaining unit is configured to determine the corpus content from the plurality of candidate corpus contents in response to a target operation on the candidate corpus contents.

According to an embodiment of the present disclosure, the corpus content obtaining unit includes a target sub-content obtaining subunit and a semantic fusion subunit.

The target sub-content obtaining subunit is configured to determine a target sub-content from the candidate corpus contents in response to a target operation on a sub-content of the candidate corpus contents.

The semantic fusion subunit is configured to perform a semantic fusion on a plurality of target sub-contents to obtain the corpus content.

According to an embodiment of the present disclosure, the apparatus for generating corpus data based on at least one large model further includes a detection module.

The detection module is configured to perform a content quality detection on at least one candidate corpus content to obtain a content quality score, where the content quality score corresponding to the at least one candidate corpus content is displayed on an interactive interface, and the target object is allowed to perform the target operation on the at least one candidate corpus content according to the displayed content quality score.

According to an embodiment of the present disclosure, the target corpus data includes the corpus content, the reasoning process information, an operation information related to the target operation, and the content quality score.

According to an embodiment of the present disclosure, the corpus content is determined by a plurality of large models conducting a dialogue based on the predetermined requirement condition, and the apparatus for generating corpus data based on at least one large model further includes a second display module and a prompt module.

The second display module is configured to display a preset instruction element related to a preset prompt instruction.

The prompt module is configured to, in response to a trigger operation on the preset instruction element, prompt, according to a dialogue prompt information in the preset prompt instruction, at least one large model to perform a dialogue content generation task according to the preset prompt instruction, where the large model is allowed to conduct a dialogue with other large models by performing the dialogue content generation task.

FIG. 7 schematically shows a structural block diagram of an artificial intelligence agent according to an embodiment of the present disclosure.

In an embodiment of the present disclosure, as shown in FIG. 7, an AI agent 700 may include an input module 710, a processing module 720, and an output module 730.

The input module 710 is configured to receive an input information.

The processing module 720 is configured to determine a target task based on the input information received by the input module, determine a large model based on the target task, and perform the method for generating corpus data based on at least one large model provided in embodiments of the present disclosure by invoking the large model, thereby obtaining an output information.

The output module 730 is configured to output the output information obtained by the processing module.

According to an embodiment of the present disclosure, the input module 710 is used to receive or sense information such as queries, requests, instructions, signals or data from the outside world (e.g., users or external environments) and convert the information into a format that the AI agent 700 may understand and process. The input module 710 is a primary link for the AI agent 700 to interact with the outside world, enabling the AI agent 700 to efficiently and accurately acquire necessary “sensory” information from the outside world and make a response to the information.

In an example, the input module 710 may input the aforementioned predetermined requirement condition, candidate corpus content, and so on.

In an example, the processing module 720 is a core support for the AI agent 700's ability to handle complex tasks. The processing module 720 may perform the method for generating corpus data based on at least one large model described above.

In an example, the performance of the processing module 720 may be closely related to the large model on which the AI agent 700 is based. In order to fully leverage the capabilities of the large model, an internal structure of the processing module 720 may be designed to be highly configurable and scalable, so as to handle various types of tasks and requirements in real-world scenarios.

In an example, after the AI agent 700 acquires the predetermined topic, the processing module 720 may perform a content generation task by using a large model based on the predetermined requirement condition to obtain corpus content, and transmit the corpus content to the output module 730.

It may be understood that although the large language models have excellent language understanding and generation capabilities, like humans, their capability to perform tasks are limited without any tools. Once the AI agent 700 is endowed with the ability to invoke tools, it may accomplish tasks such as performing mathematical calculations using a calculator, conducting data analysis using Python, or obtaining weather forecasts using a search engine.

In an example, the output module 730 may output the corpus content and target corpus data mentioned above.

The AI agent 700 according to embodiments of the present disclosure may simply and effectively enhance the level of intelligence and improve flexibility and versatility.

According to an embodiment of the present disclosure, the present disclosure further provides an electronic device, a readable storage medium, and a computer program product.

According to an embodiment of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the method described above.

According to an embodiment of the present disclosure, a non-transitory computer-readable storage medium having computer instructions therein is provided, and the computer instructions are used to cause a computer to implement the method described above.

According to an embodiment of the present disclosure, a computer program product containing a computer program is provided, and the computer program is used to, when executed by a processor, cause the processor to implement the method described above.

FIG. 8 shows a schematic block diagram of an example electronic device that may be used to implement the method for generating corpus data based on at least one large model according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 8012 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the method for generating corpus data based on at least one large model. For example, in some embodiments, the method for generating corpus data based on at least one large model may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method for generating corpus data based on at least one large model described above. Alternatively, in other embodiments, the computing unit 801 may be used to perform the method for generating corpus data based on at least one large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for generating corpus data based on at least one large model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for generating corpus data based on at least one large model, comprising:
performing a content generation task by using the at least one large model based on a predetermined requirement condition to obtain a corpus content, wherein the content generation task comprises a plurality of target tasks having dependency relationships, and the plurality of target tasks represent a reasoning process of the at least one large model for a corpus content to be generated; and
determining target corpus data based on the corpus content and a reasoning process information related to the plurality of target tasks.

2. The method of claim 1, further comprising:
displaying a reasoning process topology related to the reasoning process information, wherein the reasoning process topology comprises node elements representing the plurality of target tasks and edge elements representing the dependency relationships; and
in response to an editing operation on the reasoning process topology, updating at least one of the plurality of target tasks and the dependency relationships to obtain the reasoning process information.

3. The method of claim 1, wherein the plurality of target tasks comprise a tool invocation task; the at least one large model is configured to invoke a target tool to perform a specified task by performing the tool invocation task, to obtain an intermediate result for generating the corpus content; and the reasoning process information comprises a task description information describing an execution process of the tool invocation task.

4. The method of claim 1, wherein the performing a content generation task by using the at least one large model based on a predetermined requirement condition to obtain a corpus content comprises:
performing the content generation task by using a plurality of large models based on the predetermined requirement condition to obtain a plurality of candidate corpus contents; and
determining the corpus content from the plurality of candidate corpus contents in response to a target operation on the plurality of candidate corpus contents.

5. The method of claim 4, wherein the determining the corpus content from the plurality of candidate corpus contents in response to a target operation on the plurality of candidate corpus contents comprises:
determining a target sub-content from the plurality of candidate corpus contents in response to a target operation on a sub-content of the plurality of candidate corpus contents; and
performing a semantic fusion on a plurality of target sub-contents to obtain the corpus content.

6. The method of claim 4, further comprising:
performing a content quality detection on at least one candidate corpus content to obtain a content quality score, wherein the content quality score corresponding to the at least one candidate corpus content is displayed on an interactive interface, and a target object is allowed to perform the target operation on the at least one candidate corpus content according to the displayed content quality score.

7. The method of claim 6, wherein the target corpus data comprises the corpus content, the reasoning process information, an operation information related to the target operation, and the content quality score.

8. The method of claim 1, wherein the corpus content is determined by a plurality of large models conducting a dialogue based on the predetermined requirement condition, and the method further comprises:
displaying a preset instruction element related to a preset prompt instruction; and
in response to a trigger operation on the preset instruction element, prompting, according to a dialogue prompt information in the preset prompt instruction, at least one large model to perform a dialogue content generation task according to the preset prompt instruction, wherein the large model is configured to conduct a dialogue with other large models by performing the dialogue content generation task.

9. The method of claim 2, wherein the plurality of target tasks comprise a tool invocation task; the at least one large model is configured to invoke a target tool to perform a specified task by performing the tool invocation task, to obtain an intermediate result for generating the corpus content; and the reasoning process information comprises a task description information describing an execution process of the tool invocation task.

10. The method of claim 5, further comprising:
performing a content quality detection on at least one candidate corpus content to obtain a content quality score, wherein the content quality score corresponding to the at least one candidate corpus content is displayed on an interactive interface, and a target object is allowed to perform the target operation on the at least one candidate corpus content according to the displayed content quality score.

11. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
perform a content generation task by using the at least one large model based on a predetermined requirement condition to obtain a corpus content, wherein the content generation task comprises a plurality of target tasks having dependency relationships, and the plurality of target tasks represent a reasoning process of the at least one large model for a corpus content to be generated; and
determine target corpus data based on the corpus content and a reasoning process information related to the plurality of target tasks.

12. The electronic device of claim 11, wherein the at least one processor is further configured to:
display a reasoning process topology related to the reasoning process information, wherein the reasoning process topology comprises node elements representing the plurality of target tasks and edge elements representing the dependency relationships; and
in response to an editing operation on the reasoning process topology, update at least one of the plurality of target tasks and the dependency relationships to obtain the reasoning process information.

13. The electronic device of claim 11, wherein the plurality of target tasks comprise a tool invocation task; the at least one large model is configured to invoke a target tool to perform a specified task by performing the tool invocation task, to obtain an intermediate result for generating the corpus content; and the reasoning process information comprises a task description information describing an execution process of the tool invocation task.

14. The electronic device of claim 11, wherein the at least one processor is further configured to:
perform the content generation task by using a plurality of large models based on the predetermined requirement condition to obtain a plurality of candidate corpus contents; and
determine the corpus content from the plurality of candidate corpus contents in response to a target operation on the plurality of candidate corpus contents.

15. The electronic device of claim 14, wherein the at least one processor is further configured to:
determine a target sub-content from the plurality of candidate corpus contents in response to a target operation on a sub-content of the plurality of candidate corpus contents; and
perform a semantic fusion on a plurality of target sub-contents to obtain the corpus content.

16. The electronic device of claim 14, wherein the at least one processor is further configured to:
perform a content quality detection on at least one candidate corpus content to obtain a content quality score, wherein the content quality score corresponding to the at least one candidate corpus content is displayed on an interactive interface, and a target object is allowed to perform the target operation on the at least one candidate corpus content according to the displayed content quality score.

17. The electronic device of claim 16, wherein the target corpus data comprises the corpus content, the reasoning process information, an operation information related to the target operation, and the content quality score.

18. The electronic device of claim 11, wherein the corpus content is determined by a plurality of large models conducting a dialogue based on the predetermined requirement condition, and wherein the at least one processor is further configured to:
display a preset instruction element related to a preset prompt instruction; and
in response to a trigger operation on the preset instruction element, prompt, according to a dialogue prompt information in the preset prompt instruction, at least one large model to perform a dialogue content generation task according to the preset prompt instruction, wherein the large model is configured to conduct a dialogue with other large models by performing the dialogue content generation task.

19. The electronic device of claim 12, wherein the plurality of target tasks comprise a tool invocation task; the at least one large model is configured to invoke a target tool to perform a specified task by performing the tool invocation task, to obtain an intermediate result for generating the corpus content; and the reasoning process information comprises a task description information describing an execution process of the tool invocation task.

20. A non-transitory computer-readable storage medium having computer instructions therein, wherein the computer instructions, when executed by a processor, are configured to cause a computer to:
perform a content generation task by using the at least one large model based on a predetermined requirement condition to obtain a corpus content, wherein the content generation task comprises a plurality of target tasks having dependency relationships, and the plurality of target tasks represent a reasoning process of the at least one large model for a corpus content to be generated; and
determine target corpus data based on the corpus content and a reasoning process information related to the plurality of target tasks.
